(19) United States
(12) Patent Application Publication
(10) Pub. No.: US 2012/0084279 A1
(43) Pub. Date: Apr. 5, 2012

(54) SEARCH DETAIL DISPLAY USING SEARCH RESULT CONTEXT

(75) Inventors: Daniel J. Driscoll, Bellevue, WA (US); Sudeep Kumar, Redmond, WA (US)

(73) Assignee: Microsoft Corporation, Redmond, WA (US)

(21) Appl. No.: 12/895,722

(22) Filed: Sep. 30, 2010

(51) Int. Cl. G06F 17/30

(52) U.S. Cl. 707/722; 707/E17.009; 707/E17.014

(57) ABSTRACT

The use of search context to determine a manner in which related items are to be display to a user upon selecting a search result of a number of search results generated by a search engine. Upon the user selecting one of the search result items, details regarding the selected search result item are then displayed. The details include a listing of related items that includes at least a set of strongly related items. The context of the plurality of search result items is used to determine a manner of display of the related items. Thus, the display manner for the related items may be different according to the context.

### BACKGROUND

Search applications allow users to specify search criteria, apply the search criteria to a data source, and to receive search results. The search results include data items from the data source that satisfy the search criteria. For instance, a user might use a browser to navigate to a search engine for purposes of conducting an Internet search. The user might then enter search text (e.g., “watch”). The user might then access the results of the search from the search engine (e.g., a list of watch products).

Once the search results are obtained, the user may select on one of the data items to obtain more details about the selected data item. The detail page includes further information regarding the selected data item, as well as a minimum subset of data items that relate to the data item in a particular way. For instance, in the prior example, the user used an Internet search engine to obtain a list of watches using a user-entered text query. The user may then select one of the watches from the list to obtain further details regarding the selected watch (e.g., user ratings, price, manufacturer, reviews, etc). Related data items also displayed in this details page may include products that are also offered by the same supplier as the watch selected by the user.

These related data items include as a minimum a set of data items that are predetermined given the selected data item and given the relationship of the related data items. The ordering of the related items is either predetermined, or may in some cases be configured by the user.

### BRIEF SUMMARY

At least one embodiment described herein relates to the use of search result context to determine a manner in which related items are to be displayed to a user upon selecting a search result of a number of search results generated by a search engine. Upon the user selecting one of the search result items, details regarding the selected search result item are then displayed. The details include a listing of related items that includes at least a set of strongly related items. The context of the search results is used to determine a manner of display of the related items. Thus, the display may be different according to the context, even without user intervention in specifying a particular manner of display.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates an example computing system that may be used to employ embodiments described herein;

FIG. 2 illustrates a flowchart of a method for a computing system to present search results to a user in a manner that the details presentation regarding a selected search result item is context sensitive;

FIG. 3 shows a user interface transition diagram of a browser that may be one environment for implementing the method of FIG. 2; and

FIG. 4 illustrates a flowchart of a method for accessing related items for display in a details page in a manner that is context sensitive to the search results.

### DETAILED DESCRIPTION

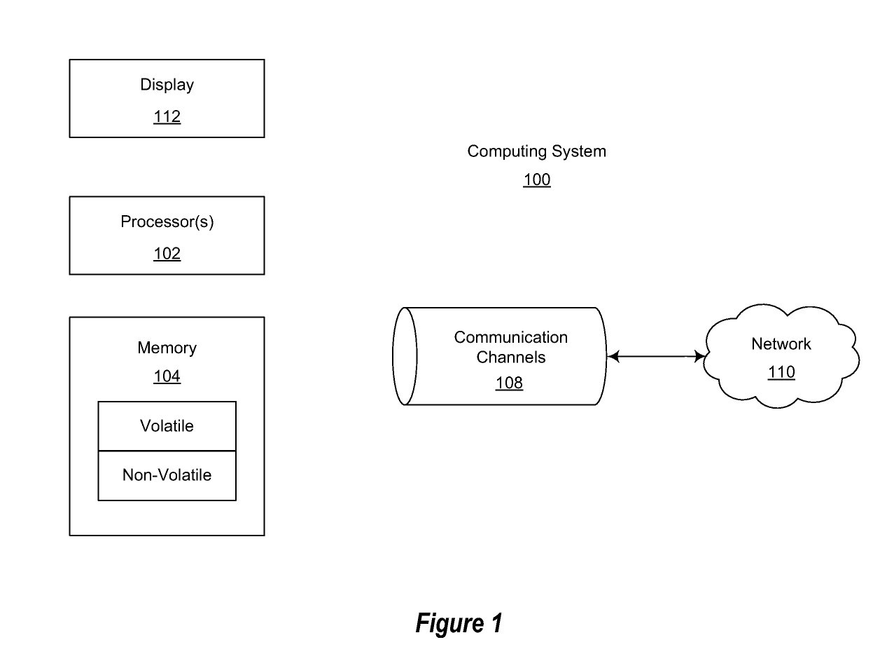

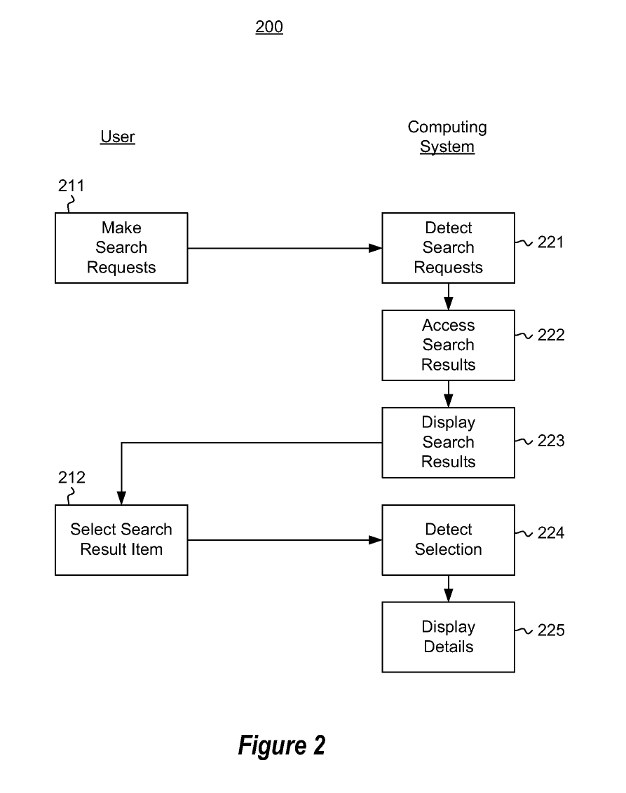

In accordance with embodiments described herein, search result context is used to determine a manner in which related items are to be displayed to a user upon selecting a search result of a number of search results generated by a search engine. Upon the user selecting one of the search result items, details regarding the selected search result item are then displayed. The details include a listing of related items that includes at least a set of strongly related items. The context of the search result items is used to determine a manner of display of the related items. Thus, the display may be different according to the context. First, some introductory discussion regarding computing systems will be described with respect to FIG. 1. Then, the embodiments of the context-based presentation of search details will be described with respect to FIGS. 2 through 4.

First, introductory discussion regarding computing systems is described with respect to FIG. 1. Computing systems are now increasingly taking a wide variety of forms. Computing systems may, for example, be handheld devices, appliances, laptop computers, desktop computers, mainframes, distributed computing systems, or even devices that have not conventionally considered a computing system. In this description and in the claims, the term “computing system” is defined broadly as including any device or system (or combination thereof) that includes at least one processor, and a memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100. The computing system 100 also may include a display 112 that may be used to provide various concrete user interfaces, such as those described herein. Computing system 100 may also contain communication channels 108 that allow the computing system 100 to communicate with other message processors over, for example, network 110.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

FIG. 2 illustrates a flowchart of a method 200 for a computing system to present search results to a user in a manner that a details presentation regarding a selected search result item is context sensitive. An example of a computing system that is capable of present search results is described above with respect to FIG. 1.

Acts that are performed by the user are illustrated in the left column of FIG. 2 under the heading “User”. Acts that are performed by the computing system are represented in the right column of FIG. 2 under the heading “Computing System”. The principles described herein are not limited to a particular data source that is being searched. In the case of an Internet search, the data source may be, for example, the Internet, with the computing system generating the search results using an Internet search engine. The data source might also be a local data source within the computing system itself. Other examples of data sources includes web services, local networks, or any other component and/or network or combination thereof that may offer up data and that may be searched. While the making of the search request, and the obtaining of search results is not an essential component of the broadest features described herein, the acts (corresponding to acts 211, 221 and 222) are shown in FIG. 2 for background purposes.

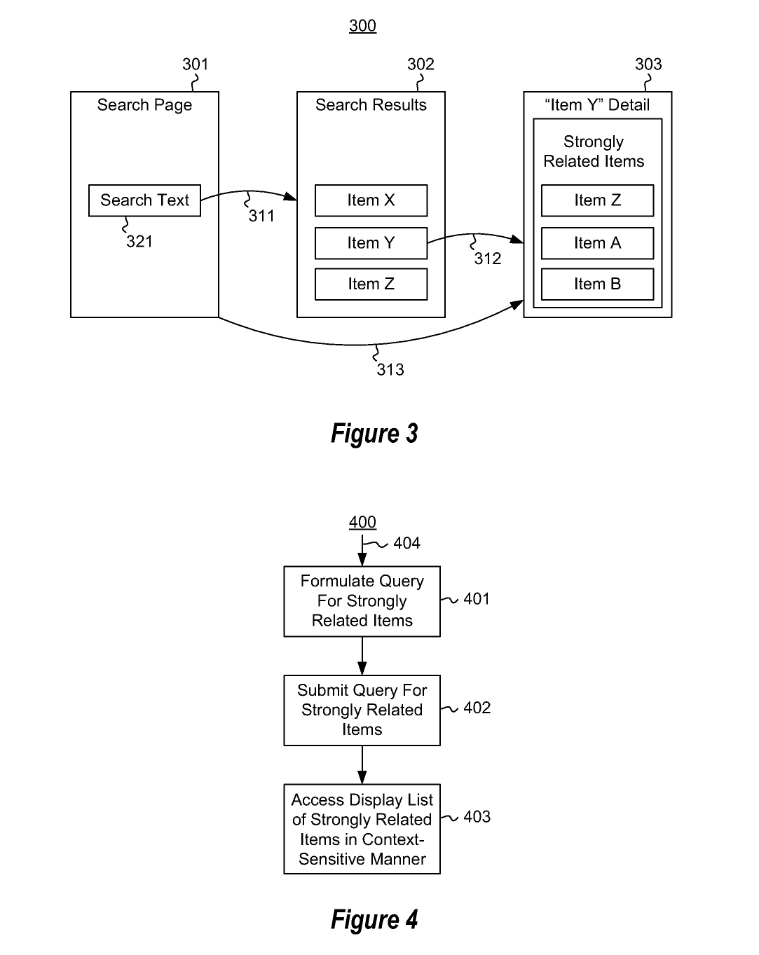

FIG. 3 illustrates a user interface transition diagram 300 showing a specific example of how the method 200 of FIG. 2 might be experienced. Accordingly, the method 200 of FIG. 2 will now be described with frequent reference to the user interface transition diagram 300 of FIG. 3. Although the user interfaces of FIG. 3 may be any user interface used to facilitate a search, regardless of the data source, the example will be described as being a browser in which a user enters search text to initiate a search. In an even more specific example, the user is interested in purchasing a new watch, and so enters the text “watch” into the search page 301.

Referring to FIG. 2, the method 200 is initiated when the user initiates a search request (act 211). In FIG. 3, for example, the user may be presented with a search page 301. In an Internet search example, the user may have used a browser to navigate to an Internet-based search engine. However, other search examples include web-site specific searches. For instance, a web site may offer a search bar that searches on the text included in that search bar, but limits the search to the web site itself. The user may initiate the search by entering search text into a search text box 321. For instance, if the user is searching for a new watch, the user might enter the text “watch” into the search text box 321 and then select some initiation control that causes the search to be initiated.

The computing system, which may for example be a search engine, then detects that the user has initiated a search request (act 221). For instance, in the prior example, the user's activation of the initiation control may be detected by the computing system. The computing system then accesses multiple search result items (act 222). In the example of an Internet search, the browser of the computing system may submit the search request to a powerful Internet search engine that constantly crawls the web indexing web page after web page. The Internet search engine would then provide the search results back to the browser. Such Internet-based search engines are known in the art, and a number of such search engines are available to anyone operating a computing system that has a web browser. However, the principles described herein are not limited to Internet-based searches supported by search engines, as previously mentioned. For instance, the search might also be limited to a particular scope such as, for example, the internal content of a web site.

In any case, whether accessed from a local data source, a remote data source, and/or the Internet, the computing system accesses multiple search result items (act 222) from the search engine, which are then displayed (act 223). Note that while acts 221 and 222 may be performed by a search engine, the remaining acts may be performed on a computing system other than the search engine. Referring to FIG. 3, the search results user interface 302 is presented to the user. From the user's perspective, since searches require very little time in terms of human perception, the user interface seamlessly transitions from the search page 301 to the search results page 302, as represented by arrow 311. In this case, the search results included three different search result items including item X, item Y, and item Z. In the more concrete example in which the user is searching for a watch (hereinafter referred to as the “watch example”), the search results page might list three popular watches.

Given the search results, the user is presented with the option of selecting the search result items to focus on a search result item. Upon selecting a particular search result item (act 212), more details regarding the search result item might be displayed, such as a more detailed description, images, specifications, and related items. The related items need not be items that resulted from the original search, but they are related to the selected search result item in some way.

Referring to FIG. 2, upon detecting the user-selection of one of the search result items (act 224), the computing system displays details about the selected search result items (act 225). Such details include a set of strongly related items. In this description, and in the claims, a set of “strongly related items” with respect to a selected search result item is a set of items that are to be displayed when the corresponding search result item is selected. The related items are to be displayed regardless of the context of the search results. Referring to FIG. 3, suppose the user selects search result item Y from the search results user interface 302, the “Item Y” detail user interface 303 would then appear. In this case, the details regarding Item Y include three items (Item Z, Item A and Item B) that are manufactured by the same manufacturer as Item Y. Item X is not manufactured by this manufacturer, and is thus it is not included in the strongly related items that are displayed. For instance, in the watch example, the user might select a particular watch from the search results, which could provide the user with further details including items that are also provided by the same manufacturer as the watch selected in the search results page 302. The transition from the search results page 302 to the Item Y detail page 303 due to the selection of Item Y in the search results page 302 is represented by arrow 312.

In this example, “strongly related items” may be items from same manufacturer, which are always displayed with the corresponding search result item is selected. Related items are items which are not from the same manufacturer in which case the items may appear on the same page of search results for a finite term.

Note that Item Z is both a strongly related item (shown in details page 303), as well as a search result item (shown in details page 302) though the details page 303 is for Item Y. Items A and B are items that were not search result items presented in the search results page 302 because they were not related to the user-entered search text. Whenever Item Y is selected from a search results page, a certain set of strongly related items is displayed regardless of the context of the search results. In this case, Items A, B and Z would be displayed whenever Item Y is selected in a search results page. There may be additional items that are displayed as related items, but at least these Items A, B, and Z are to be displayed.

In accordance with the principles described herein, the context of the search results is used to determine a display order for displaying the set of strongly related items. In FIG. 3, the influence of the search result context on the ordering of the related items is represented by arrow 313. In the example of FIG. 3, note that Item Z is listed first. This is because Item Z satisfied the original search request based on the search text. Items A and B did not. If the search result context had not been considered, then the set of strongly related items might have been arbitrarily ordered (perhaps by name), resulting in Item Z being listed last even though it is most relevant to the context of the original search results. Thus, Item Z appears before Items A and B in the Item Y detail page 303. Stated differently, the display order of the related items in based on the context of the search string used in the search. However, other aspects of context may be used to influence the ordering of the related items. Furthermore, any manner of display (not just display order) of the set of strongly related items may be adjusted according to the search results context.

For instance, the identity of the web site in which the user initiated the search may be considered in determining the display order for the minimum set of related items. Suppose that the user initiated the search from a web site devoted to sports enthusiasts. Now suppose item A is a wrist-worn device that detects calories burned. In that case, Item A might appear at the top of the list. In an example of another manner of display, perhaps Item A would be highlighted, appear in larger text, have a more detailed picture, and/or have more comprehensive written description.

As another example, suppose the user is located in a particular cold temperature region. Now suppose Item B is a light-weight coat with good insulation properties that sells well in that region. Item B might be then ordered to the top of the related items list. Alternatively or in addition, Item B might be highlighted, appear in larger text, have a more detailed picture, and/or having a more comprehensive written description.

As another example, the identity of the user himself/herself may have influence on the search results. For instance, suppose that the user has already purchased item Z, and Item Z is of such a character that multiple purchases would be useless. In that case, Item Z might be moved lower into the display order of the related items, or Item Z might be otherwise visually deemphasized as compared to Item A and Item B.

Other examples of search context include, but are by no means limited to, the device type that the search request was initiated from, the language of the search text (e.g., Japanese), the level of advancement of the search text, and so forth.

FIG. 4 illustrates a flowchart of a method 400 for accessing the set of strongly related items in the order in which they will be displayed when the selected search result item is selected. In the flowchart of FIG. 2, it is assumed that the identities of the set of related items are available at the time they are displayed upon selecting the corresponding search result item. The identities of the related items may have been obtained as late as just in time to be displayed after the corresponding search result item is selected. However, they may also be obtained earlier at the time that the original search results are received, or at some point in-between.

In accordance with one aspect described herein, the related set of items are not only obtained, but obtained in the proper display manner. For instance, if the display manner were a display order, the set of related items might be obtained as a list that is already ordered considering the search result context. This is done by properly and automatically formulating a search query (act 401) for the strongly related items. This search query is not to be confused with the user-initiated search request of act 211 of FIG. 2.

Arrow 404 represents that certain contextual data regarding the search results will be provided to help formulate the search query. For instance, the identity of the web site that the user used to enter the search request, the location of the user that initiated the original search request, and search text used by that use, and so froth.

This automatically formulated search query is then provided to a search engine (act 402). This search engine may be the same as or different than the search engine the provided the search results in act 222 of FIG. 2. Examples of commercially available search engines include FAST ESP and the GOOGLE Search Applicance. The search query is structured such that the search engine provides the set of strongly related items in a manner that facilitates the display manner that is based on the search result context. For instance, in the example below, the query is structured such that the set of strongly related items is listed in the order in which they are to be displayed. The results are then displayed in the proper display manner (act 403).

As an example of how a query for a set of related items may be formed, suppose that the original search results returned a list of watches based on a search text of “watch”. Now suppose the set of strongly related items are those items that are manufactured by the same manufacturer (e.g., Acme). A query is thus structured so that all watches manufactured by Acme are returned. The query might also specify a filter by company=Acme to ensure that documents which satisfy the “watches” term but which are not from Acme are not displayed. The final syntax here is similar to: query=“watches OR company:acme”+filter=“company: acme”.

The following is an actual example of a specifically structured query that is compatible with the FAST ESP search engine:

http://search_engine:16089/wssearch/xmlsearch2.jsp?searchProfile=products&query=watches+company%3aAcme&queryType=all&paramName=filter&paramVal=company%3aAcme+&hits=10&offset=0
Effectively this query returns all products from Acme, with watches appearing at the top of the list.

Accordingly, the principles described herein permit for the context-based presentation of related items when a search result item is selected. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of a computing system presenting search results to a user, the method comprising:
an act of the computing system detecting a user-selection of a search result item from amongst a plurality of search result items that were generated by a search engine; and
an act of the computing system displaying details about the selected search result item in response to the user selecting the selected search result item, wherein the details includes at least a set of strongly related items,
wherein a context of the plurality of search results is used to determine a manner to display for displaying the minimum set of related items.

2. The method in accordance with claim 1, wherein the context used to determine the manner of display is at least a portion of a search string of a user-initiated search request submitted to the search engine that resulted in the generation of the plurality of search result items.

3. The method in accordance with claim 1, wherein the context used to determine the manner of display is at least an identity of a web site in which was made a user-initiated search request that resulted in the plurality of search result items.

4. The method in accordance with claim 1, wherein the context used to determine the manner of display is at least a geographical location of a user that initiated a search request that resulted in the plurality of search results.

5. The method in accordance with claim 1, wherein the context used to determine the manner of display is at least an identity of a user that initiated a search request that resulted in the plurality of search results.

6. The method in accordance with claim 1, wherein the plurality of search result items were generated in response to an Internet search request.

7. The method in accordance with claim 1, wherein the plurality of search result items were generated in response to a local search request.

8. The method in accordance with claim 1, further comprising:
an act of accessing the set of strongly related items in the order in which they will be displayed when the selected search result item is selected.

9. The method in accordance with claim 8, wherein the act of accessing comprising:
an act of automatically formulated a search query; and
an act of submitting the search query to a search engine, wherein the search query is structured such that the search engine provides the set of strongly related items in the order in which they are to be displayed.

10. The method in accordance with claim 1, wherein the manner of display comprises an order of display for the set of strongly related items.

11. A computer program product comprising one or more computer storage media having thereon computer-executable instructions that, when executed by one or more processors of the computing system, cause a computing system to perform the following:
an act of the computing system detecting a user-selection of a search result item from amongst a plurality of search result items that were generated by a search engine; and
an act of the computing system causing a plurality of related items to be displayed in a particular manner in response to the user selecting the selected search result item, wherein the plurality of related items includes at least a set of strongly related items, wherein a context of the plurality of search results is used to determine the particular manner for displaying the set of strongly related items.

12. The computer program product in accordance with claim 11, wherein the context used to determine the manner of display is at least a portion of a search string of a user-initiated search request submitted to the search engine that resulted in the generation of the plurality of search result items.

13. The computer program product in accordance with claim 11, wherein the context used to determine the manner of display is at least an identity of a web site in which was made a user-initiated search request that resulted in the plurality of search result items.

14. The computer program product in accordance with claim 11, wherein the context used to determine the manner of display is at least a geographical location of a user that initiated a search request that resulted in the plurality of search results.

15. The computer program product in accordance with claim 11, wherein the context used to determine the manner of display is at least an identity of a user that initiated a search request that resulted in the plurality of search results.

16. The computer program product in accordance with claim 11, wherein the plurality of search result items were generated in response to an Internet search request.

17. The computer program product in accordance with claim 11, wherein the plurality of search result items were generated in response to a local search request.

18. The computer program product in accordance with claim 11, wherein the computing system is further caused to perform the following when executing the computer-executable instructions:
an act of accessing the set of strongly related items in the order in which they will be displayed when the selected search result item is selected.

19. The computer program product in accordance with claim 18, wherein the act of accessing comprises:
an act of automatically formulated a search query; and
an act of submitting the search query to a search engine, wherein the search query is structured such that the search engine provides the set of strongly related items in the order in which they are to be displayed.

20. A computer program product comprising one or more computer-readable media having thereon computer-executable instructions that, when executed by one or more processors of the computing system, cause a computing system to perform the following:
an act of the computing system detecting a user-selection of a search result item from amongst a plurality of search result items that were generated by a search engine;
an act of accessing a set of strongly related items in the order in which they will be displayed when the selected search result item is selected, wherein the act of accessing the set may occur before, during or after the user-selection of the selected search result item; and
an act of the computing system causing a plurality of related items to be displayed in a particular order in response to the user selecting the selected search result item, wherein the plurality of related items includes at least the set of strongly related items, wherein a context of the user-initiated search request is used to determine a display order for displaying the minimum set of related items.
